(19) United States
(12) Patent Application Publication
(10) Pub. No.: US 2019/0349976 A1
(43) Pub. Date: Nov. 14, 2019

(54) TRANSMISSION AND RECEPTION PROCEDURES FOR ASYNCHRONOUS TRANSMISSION SCHEMES

(71) Applicant: IDAC HOLDINGS, INC., Wilmington (DE)

(72) Inventor: Marian RUDOLF, Montreal (CA)

(21) Appl. No.: 16/324,434

(22) PCT Filed: Aug. 10, 2017
(86) PCT No.: PCT/US17/46212

§ 371 Date: Feb. 8, 2019

(51) Int. Cl. H04W 72/12; H04W 72/00

(52) U.S. Cl. CPC H04W 72/1289; H04W 72/005; H04W 72/1205; H04W 72/1273

(57) ABSTRACT

Systems, methods, and instrumentalities are disclosed for 5G NR broadcast multicast data transmission. A wireless transmit/receive unit (WTRU) may receive a configuration to determine a transmission timing interval (TTI) for receiving a downlink transmission. The WTRU may identify a downlink timing reference. The WTRU may determine a first TTI in which the downlink transmission can occur based on the downlink timing reference and a first rule associated with the configuration. The WTRU may determine a second TTI in which the downlink transmission can occur based on a second rule associated with the configuration.

### BACKGROUND

Mobile communications continue to evolve. A fifth generation may be referred to as 5G.

### SUMMARY

Systems, methods, and instrumentalities are disclosed for % New Radio (NR) scheduling and transmission of semi-periodic or asynchronous transmissions. For example, the techniques herein may be used in order to transmit and/or receive a broadcast multicast data transmission. Example procedures or protocols are provided for downlink (DL) control and data transmission, DL scheduling, and L2/3 user plane. A wireless transmit/receive unit (WTRU) and or a network transmission/reception point (TRP) may use asynchronous data delivery based on configurable rules that dictate when a transmission may occur based on observed criteria.

For example, rule-based asynchronous transmission methods may be used to deliver Multimedia Broadcast Multicast Services (MBMS) data. A WTRU and/or TRP may use tables and/or indices to implement stream-based multiplexing. DL L2/3 Uu design may support scheduling in Multicast-Broadcast Single-Frequency Network (MBSFN) and Single Cell Point-To-Multipoint (SC-PtM) modes. Timing-based data delivery may be provided for MBMS or other types of services. The WTRU and/or TRP may be configured to determine appropriate transmission times is the presences of TTIs of varying length. Coordinated TTI allocations may be used and may be autonomously adjustable. The WTRU and/or TRP may utilize absolute or relative reference timing in order to determine potential data delivery occasions.

By utilizing configurable rules in order to determine time periods at which possible allocations may occur, data delivery may be scheduled and acquired by WTRUs in the presence of variable TTIs and flexible timing relationships between control and data signaling. Radio resource allocation may be flexible in time and frequency domains. Seamless transition and inter-operability may be provided between unicast-based, SC-PtM-based and MBSFN-based data delivery modes, for example for MBMS services. MBMS may be operated using multiple concurrently configured MBMS channelization and transmission configurations. MBMS reception may be enabled without relying on always-on DL control and system information signaling.

A WTRU may receive a configuration to determine a transmission timing interval (TTI) for receiving a downlink transmission. The WTRU may identify a downlink timing reference. The WTRU may determine a first TTI in which the downlink transmission can occur based on the downlink timing reference and a first rule associated with the configuration. The WTRU may determine a second TTI in which the downlink transmission can occur based on a second rule associated with the configuration.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is an example of framing and timing for 5G NR in FDD mode.

FIG. 3 is an example of framing and timing for 5G NR in TDD mode.

FIG. 4 is an example of dynamic multiplexing of unicast and broadcast/multicast data using asynchronous multiplexing mode.

FIG. 5 is an example of MBMS service identification with concurrently multiplexed MBMS services.

FIG. 6 is an example of MBMS association information with concurrently multiplexed MBMS services.

FIG. 7 is an example of MBMS content delivery and/or timing synchronization between an eNB and WTRU.

FIG. 8 is an example of autonomously adjustable common TTI allocations for MBMS transmission and reception.

FIG. 9 is an example of an MBMS reference timing determination using a universal timing source.

FIG. 10 is an example of MBMS reference timing determination using a relative timing source.

### DETAILED DESCRIPTION

A detailed description of illustrative embodiments will now be described with reference to the various Figures. Although this description provides a detailed example of possible implementations, it should be noted that the details are intended to be exemplary and in no way limit the scope of the application.

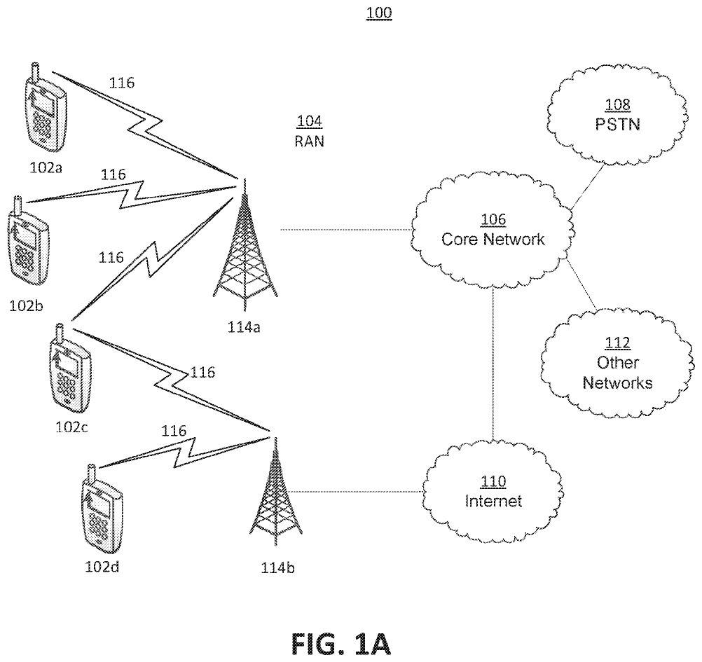

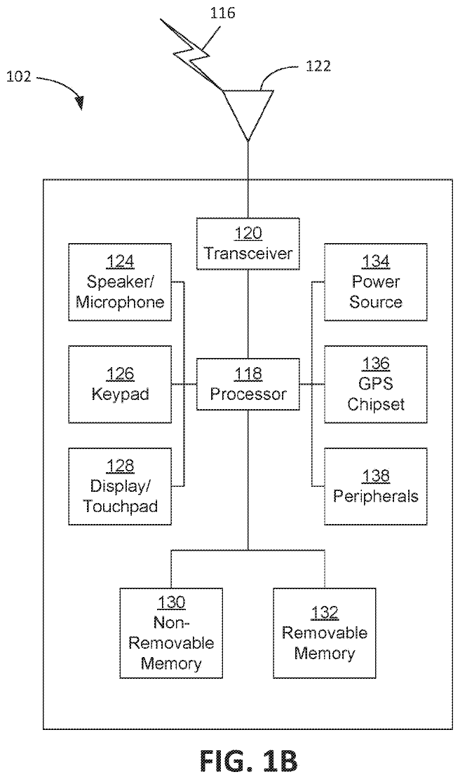

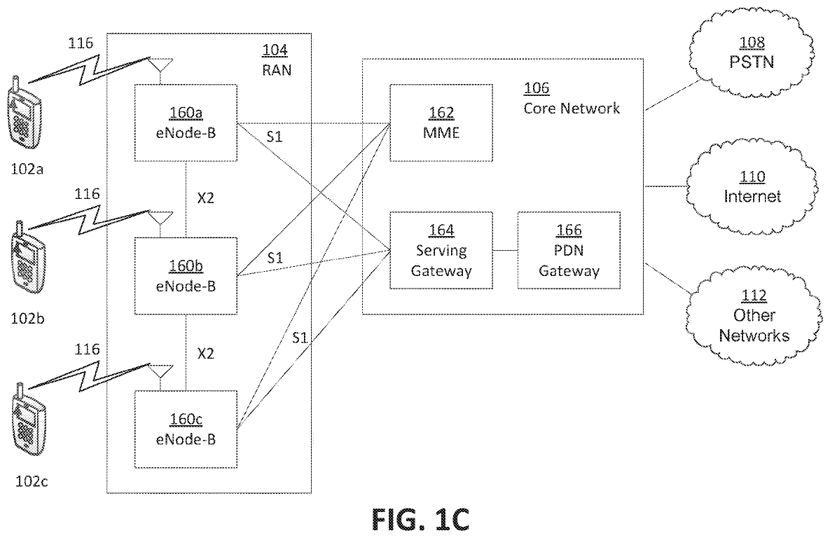

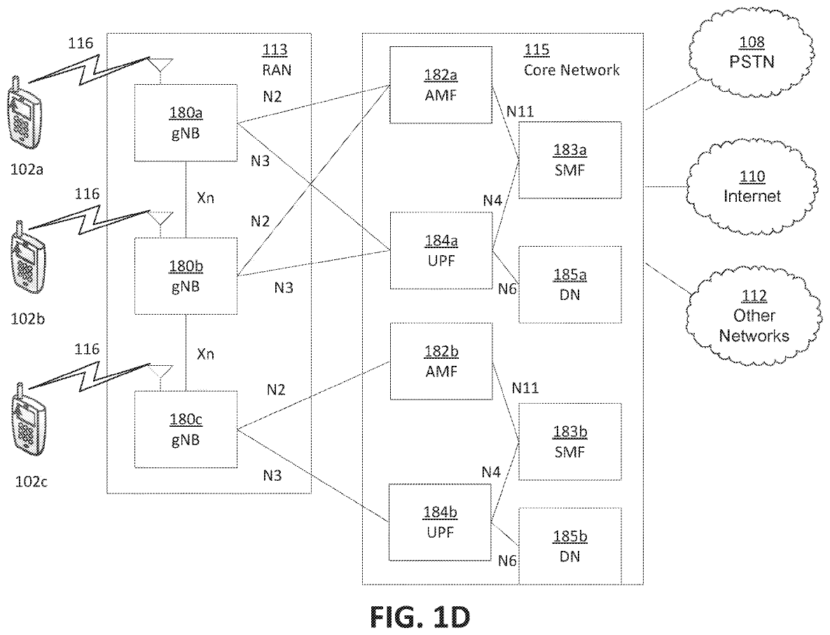

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Terrestrial broadcast networks such as digital TV broadcasting may cover large areas and may provide no or limited data transmission to individual users. Broadcast networks for satellite, terrestrial or cable based content delivery such as DVB-S/T/C/S2/C2 may use asynchronous transfer, e.g., based on MPEG-2 packet elementary streams.

Cellular networks such as 2G GSM/EPGRPS, 3G WCDMA/HSPA, or 4G LTE/LTE-A may deliver data to individual users. For example, 3G WCDMA and 4G LTE-based cellular communications may support a Multimedia Broadcast Multicast Services (MBMS) feature. MBMS may comprise a set of physical layer channels, signaling protocols and network functions that may support distribution of broadcast and multicast content to terminals using cellular telecommunications. Similar MBMS functionality may be provided for 3G EVDO based cellular access networks. MBMS may be provided, for example, for 3G WCDMA and/or as eMBMS feature for 4G LTE-based cellular networks.

In order to provide enhancements to MBMS (e.g., eMBMS) and other types of transmissions that may have been originally designed assuming fixed or synchronous timing patterns, one or more rules may be defined, such as counting procedures, which may allow such systems to operate when the timing relationships are no longer completely sysnchronous (e.g., systems with varying TTI lengths). For example, a WTRU and/or TRP may implement the techniques described herein in order to determine one or more of discontinuous reception (DRX) schedules, discontinuous transmission (DTX) schedules, channel state information (CSI) and/or channel quality information (CQI) reporting opportunities, scheduling request (SR) transmission and/or reception opportunities, and/or semi-persistent scheduling (SPS) transmission and/or reception opportunities, MBMS transmission and/or reception opportunities, measurement gaps, and/or transmission and/or reception opportunities for any other transmission that had been previously performed in a periodic manner in systems that utilized synchronous subframe timing.

The techniques described herein may allow for improvements to inter-frequency reception of MBMS content on SCells with carrier-aggregation capable LTE handsets, prioritized cell selection for serving cells carrying MBMS data or introduction of WTRU measurements, e.g., to report MBMS signal quality like signal strength and multicast channel (MCH) block error rate (BLER), orthogonal frequency division multiplexing (OFDM) channelization with a cyclic prefix (CP) larger than 100 us (e.g., for propagating very large macro cells in sub-1 GHz bands), mechanisms to use (e.g., all) available LTE subframes for MBMS channels and elimination of a unicast control region in MBSFN-reserved subframes with LTE.

MBMS content may be typically delivered to users/terminals using unicast channels. A point-to-multipoint (PtM) delivery mechanism may be used, for example, when the same MBMS content may be transmitted to many users. There may be multiple different PtM delivery modes (e.g., MBSFN mode and SC-PtM mode) for eMBMS (e.g., in LTE-based networks).

MBMS content may be transmitted using individual unicast channels to users, for example, by a downlink channel, e.g., a unicast physical downlink shared channel (PDSCH). A unicast PDSCH may allow for the use of link adaptation with channel state feedback from the user, for example, even when the broadcast/multicast payload may be duplicated multiple times while being delivered over the radio to multiple users individually. A PDSCH may (e.g., also) support spatial multiplexing. The spectral efficiency may be much higher than may be achieved with PtM channels, for example, when using unicast PDSCH for MBMS data delivery to a user. The use of individual unicast channels may be used, for example, when few or several users require MBMS content delivery. Unicast PDSCH for MBMS delivery may be implemented, for example, when a user is in RRC Connected Mode.

MBMS content may be transmitted, for example, using an MBSFN mode. Neighbor cells may transmit the same content in a subframe in a time-synchronized manner and the resulting OFDM signal in LTE may (e.g., from the terminal point-of-view) appear as a single transmission with more time dispersion. Interference may be reduced and received signal strength may be increased at a cell edge. This kind of transmission principle may (e.g., in LTE) be referred to as MBSFN. An LTE PMCH may use eCP, e.g., for MBMS transmission in MBSFN mode. A physical multicast channel (PMCH) may contain a (e.g., much) denser pilot pattern in time and frequency than the PDSCH, e.g., to support the larger frequency selectivity inherent in an SFN channel. There may not be user feedback (e.g., in terms of channel state information). Multi-antenna transmissions may not be defined for PMCH and spatial multiplexing modes may not be supported. Tracking of a users' location and movement may not be performed, for example, for MBMS delivery using MBSFN mode. Users may receive MBMS content without explicitly notifying an LTE network. MBMS content may be received, for example, in RRC Idle Mode and in RRC Connected Mode. Information that may be used to receive and decode MBMS content may be handled as separate and independent subscription information independent of LTE access credentials. An entire subframe may be allocated to PMCH (e.g., with the exception of the unicast control region carrying PDCCH in the first 1-2 OFDM symbols of the subframe), for example, when PMCH is configured. In an example, up to six subframes per frame may be set aside for MBSFN in LTE FDD cells. The PMCH may not use hybrid automatic repeat request (HARQ) or radio link control (RLC) quick repeat. In an example, (e.g., only) the first RV may be transmitted. Channel estimation by the terminal in an MBSFN subframe may exploit (e.g., all) reference signals across the (e.g., entire) channel bandwidth. Channel estimation across MBMS carrying subframes may not be assumed, for example, when the MBSFN configuration of the MCH may change. MBSFN mode may be used, for example, when (e.g., many) geographically dispersed users may need delivery of MBMS content.

MBMS content may be transmitted, for example, using Single Cell Point-to-Multipoint (SC-PtM) mode. SC-PtM mode may be based on PDSCH. In an example, nCP or eCP may be used. DCIs on (e)PDCCH may be modified, for example, to allow for group reception of a PDSCH and/or to deliver change notifications for an SC-PtM PDSCH. SC-PtM mode may be supported in RRC Idle and RRC Connected Modes. There may not be feedback from individual users (e.g., similar to MBSFN mode). MBMS content may be multiplexed into the same subframe with other concurrently transmitted unicast data channels, which may provide an advantage for SC-PtM mode. An MBMS payload carried on SC-PtM PDSCH may be small in a particular subframe. The remainder of a subframe may be reclaimed for dynamic unicast scheduling. Reclaiming may not occur in MBSFN mode, for example, when the PMCH may (e.g., must always) occupy the (e.g., entire) transmission bandwidth in a (e.g., any) MBSFN reserved subframe. SC-PtM may be implemented, for example, when there are (e.g., many) users requesting MBMS content located in close vicinity such as in small urban macro or micro cells.

The same MBMS content may be transmitted to multiple users located in a specific area, for example, in MBSFN mode and in SC-PtM mode. Multiple users in an area provided with the same content may be referred to as an MBMS service area. An MBMS service area may comprise multiple cells. A point-to-multipoint (PtM) PMCH radio resource may be configured in a (e.g., each) cell. Users simultaneously subscribed to an MBMS service may simultaneously receive a transmitted signal. There may be multiple MBMS services in a given cell. MBSFN and SC-PtM delivery modes for MBMS content may use distinct physical channels. MBSFN and SC-PtM delivery modes may share the same MBMS protocol (e.g., in upper protocol layers) and may rely on the same MBMS network architecture. MBSFN mode and SC-PtM mode may use the concept of SIB-based acquisition and multicast control channel (MCCH) and MAC Control Elements announcing multicast traffic channel(s) (MTCH(s)) for an MBMS scheduling period. A difference between MBSFN mode and SC-PtM mode may be that MBSFN mode may involve setting aside MBSFN-reserved subframes for reception of eMBMS while SC-PtM mode may not. In an example, MCCH, MAC CEs, MTCH(s), CSA, MSA and MSI may be used in the same way.

Content distribution (e.g., for eMBMS in 3G and 4G) may be performed and organized in a self-contained and separate logical service plane. An eMBMS GW may forward MBMS user data from a BM-SC to one or more eNBs. An eMBMS GW may support session control signaling (e.g., start/stop) towards E-UTRAN, e.g., via an MME. An MCE may perform admission control and radio resource allocation for eNBs. An MCE may be important, for example, when operating in MBSFN mode across multiple LTE cells. A SYNC protocol may be employed, for example, for user-plane content synchronization between BM-SC and eNBs. A SYNC protocol may allow for proper timing of radio frame transmission and detection of packet losses. Termination may occur in the BM-SC.

Radio resources may be allocated in LTE eMBMS PtM modes.

LTE eMBMS may (e.g., extensively) use time-domain multiplexing on the Uu, for example, when transmitting MBMS data and its associated control signaling. This mechanism (e.g., in L2/3) may be described, for example, by a Common Subframe Allocation (CSA) period and MCH Scheduling Period (MSP), which may apply to MBSFN mode and SC-PtM mode for delivery of MBMS content, e.g., in LTE networks.

An MCH MAC subheader may indicate (e.g., in MBSFN mode) (SC-)MCCH and (SC-)MTCH through designated Logical Channel IDs. SC-MCCH and SC-MTCH transmission may be indicated (e.g., in SC-PtM mode) by a logical (e.g., channel specific) RNTI value, for example, on PDCCH. There may be a 1:1 mapping between TMGI and G-RNTI, which may be used for reception of the DL-SCH to which a SC-MTCH may be mapped. (SC-)MCCH may provide a list of MBMS services with ongoing sessions transmitted on (SC-)MTCH(s), which may include TMGIs associated therewith. Broadcast type TMGIs may be allocated by a BM-SC and may be transmitted to a WTRU, for example, via an MBMS Service Announcement mechanism. Multicast TMGIs may be transmitted to a WTRU, for example, via an MBMS Multicast Service Activation procedure.

MCHs that may be part of the same MBSFN area may (e.g., in MBSFN mode) occupy a pattern of MBSFN subframes that may be known as a Common Subframe Allocation (CSA). A CSA may be periodic, e.g., in the order of several hundred milliseconds. Subframes used for transmission of MCH may (e.g., must) be configured as MBSFN subframes. MBSFN subframes may be configured for other purposes (e.g., as well), for example, to support the backhaul link in the case of relaying. Allocation of MBSFN subframes for MCH transmission may be identical across an MBSFN area, for example, to provide MBSFN gain. This may be the responsibility of the MCE.

Transmission of an MCH may follow the MCH Subframe Allocation (MSA), for example, in MBSFN and SC-PtM modes. MSA may be periodic and may (e.g., at the beginning of each MCH Scheduling Period (MSP)) have a MAC control element, for example, to transmit MCH Scheduling Information (MSI). MSI may indicate which subframes may be used for certain MTCHs in an upcoming scheduling period. LCIDs of MTCHs may be used to mark end subframes in a scheduling period. An MSI may indicate the last MCH subframe to be used for a particular MTCH, for example, when not all possible subframes are used or required for MTCH transmission in the scheduling period. Remaining subframes not used for MBMS transmission may be reused by an eNB for unicast scheduling (e.g., for one or more WTRUs). Different MCHs may be transmitted in consecutive order within a CSA period. Subframes used by MCH n in a CSA may be transmitted before subframes used for MCH n+1 in the same CSA period.

A transport format, e.g., data MCS for a MCH TB in a given subframe, may be signaled as part of an MCCH. An MCH transport format may differ between MCHs. The MCH transport format may (e.g., must) remain constant across subframes used for the same MCH. An MCCH-specific transport format, e.g., a control MCS signaled as part of system information, may be used, for example, with respect to subframes used for the MCCH and the MSI. An MCCH-specific transport format may be provided as part of system information in SIB13, for example, in MBSFN mode. SIB20 may be used, for example, in SC-PtM mode. System information may (e.g., also) provide information about scheduling and modifications periods of an MCCH.

A WTRU may (e.g., first) read SIB13/15 (e.g., MBSFN mode) or SIB20 (e.g., SC-PtM mode), for example, to learn about MBMS in a serving cell. A WTRU may (e.g., for each MBSFN area) read MCCH, which may provide information about MBMS services being offered or active, the CSA pattern and period and may (e.g., for each MCH in the MBSFN area) read transport format and scheduling period. Information about the CSA period, CSA pattern and MSP may be obtained (e.g., by the WTRU) from the (SC-)MCCH.

CSA period, CSA pattern, and MSP parameters may remain fixed for a relatively long time. The terminal may receive the MSI and the subframes in which the MTCH carrying the MBMS service of interest are located. This may reduce the power consumption in the terminal, for example, by permitting it to sleep in most of the subframes. The information provided on the MCCH may be updated, for example, when starting a new service. Repeatedly receiving (e.g., by a terminal) an (SC-)MCCH may increase terminal power consumption. LTE may use a fixed schedule for (SC-)MCCH transmission in combination with a change-notification mechanism, for example, to reduce power consumption.

A 5G air interface may support a number of use case families, e.g., eMBB, URLLC and mMTC. Support for these use case families may result in significant changes to a radio interface (e.g., compared to LTE). Support for massive antenna configurations may lead to changes in the way pilot signals are assigned, transmitted and tracked in base stations and terminals. Support for minimum overhead in 5G deployments may involve changes to system acquisition and initial access, e.g., to avoid always-on types of DL control signals and channels sent by LTE base stations that may result in high amounts of residual background interference even when LTE cells may not carry traffic. Support for flexible radio access in 5G may involve a high degree of spectrum flexibility and spectral containment for multiple access waveforms, for example, to multiplex signals of different users with different numerology and parameterization onto a channel. 5G New Radio (NR) flexible radio access may include support of different duplex arrangements, different and/or variable sizes of available spectrum allocations to different terminals, variable timing and transmission durations for DL and UL data transmissions, variable timing of DL assignment and UL grant signaling and corresponding control signals. Flexible TTI lengths and asynchronous UL transmissions may be supported.

LTE-based (e)MBMS channel design, resource allocation and signaling procedures may not be employed in the context of 5G NR radio access networks, for example, due to changes in the multiple access scheme and multiplexing and scheduling approach (e.g., comparing LTE and 5G NR). Further, 5G NR may utilize transmission time intervals (TTIs) of varying length, meaning LTE-like determinations of timing relationships may be difficult to implement.

MBMS may use a fixed periodic schedule in LTE. LTE may use fixed length 1 ms subframes. eNB transmission and WTRU reception using CSA, MSA, and MSP transmission patterns may be defined and configured as a function of these defined transmission intervals. Transmission of MSI may occur in defined fixed subframes using a small set of configured control MCS for blind decoding by the WTRU, e.g., to avoid the need for L1 DL assignment signaling. The LTE approach for MBMS radio resource allocations may not be used for 5G NR, for example, due to the presence of variable-length TTIs and (e.g., required) support for concurrent multiplexing of different users' different TTI lengths in variable length DL transmissions. MBMS data delivery in 5G NR may be scheduled for and be acquired by WTRUs in the presence of variable TTIs. Flexible timing relationships between control and data signaling characteristic for 5G NR radio access networks may be accounted for in MBMS implementation for NR.

LTE MBSFN mode for MBMS may, e.g., support allocation of the (e.g., entire) transmission bandwidth in a given subframe. This may result in a strict TDM allocation principle and MBSFN reserved subframe allocations for LTE-based MBMS, which may (e.g., should) be avoided in 5G NR networks. An ability to dynamically assign and reassign transmission resources in time and frequency as a function of available MBMS and unicast data may support 5G NR operation. MBMS may be used for MBMS service, e.g., TV channels that may have high data rates and large data payloads. MBMS may be used for firmware or software updates running at lower data rates using smaller data payloads in the background for devices such as mMTC. MBMS may be used as a DL delivery mechanism for V2X in eNB-controlled resource allocation. MBMS use cases may be implemented with flexibility, e.g., small MBMS data payloads may be supported as well as large data payloads in terms of resource allocation. More time resources may be allocated for broadcast/multicast channels, for example, when repetition may be used to meet MBMS link budgets for certain devices and payload types. 5G NR may be implemented with flexible radio resource allocation in time and frequency domain considering MBMS and unicast data delivery to terminals.

LTE MBSFN and SC-PtM modes may not be used inter-changeably in LTE. A WTRU may be configured to receive eCP PMCH in MBSFN-reserved subframes or (e.g., alternatively) multicast PDSCH in regular DL subframes. MBMS reception in a delivery mode may be interrupted and WTRUs may re-acquire and re-decode MBMS data, for example, upon transition to a new cell due to mobility or upon network reconfiguration of MBMS services in a cell due to more users. 5G NR may be implemented to allow a seamless transition and inter-operability between unicast-based, SC-PtM based and MBSFN-based MBMS data delivery modes.

Acquisition of NR MBMS DL control information across (e.g., all) protocol layers may be possible for terminals with different supported operational bandwidth. Devices may be configured to use different OFDM numerologies. LTE-based MBMS may support a (e.g., only one) OFDM numerology (e.g., eCP using 15 kHz spacing). Delivery of MBMS in 5G radio access networks may provide support for concurrent delivery using multiple OFDM numerologies. Small sub-carrier spacing with long CP lengths may characterize an MBMS transmission in large macro cells with over-the-rooftop omnidirectional antennas. Short OFDM symbols with small CP lengths may characterize MBMS delivery in 5G NR small cells where range may have lesser importance while multiplexing ability with concurrent unicast data services may have greater importance. LTE-based MBMS may not support such functionality. 5G NR based MBMS may be operated using multiple concurrently configured MBMS channelization and transmission configurations.

Reception of LTE-based MBMS may rely on availability of always available DL broadcast signaling, for example, to decode the MCCH and to receive MCCH and MTCHs in the MBMS carrying subframes. An LTE WTRU may acquire MIB, SIB1, SIB2, SIB13, and SIB15, for example, to start decoding the MCCH. A heavy payload DL background control signaling may be transmitted in a 5G NR cell for a limited purpose of MBMS reception, for example, even when there may not be any traffic. 5G NR may be implemented so that MBMS reception may be enabled without relying on always-on DL control and system information signaling.

LTE-based MBMS may be insufficient for 5G NR radio access implementations. MBMS data content may be delivered in 5G NR networks to support the delivery of MBMS broadcast/multicast content to terminals using 5G NR cellular access.

Example protocols are provided for MBMS data delivery from eNB to WTRU. Data delivery mechanisms may provide examples of timing, framing, scheduling and WTRU based decoding.

In an example, MBMS network and protocol architecture may be unchanged in the user plane above L2/3. Examples are provided for MBMS data delivery from eNBs to WTRUs in L23. MTCH and MCCHs may be implemented to suit a variety of implementations.

Asynchronous data transfer may be different compared to LTE MBMS. Asynchronous data transfer may provide a dynamic packet stream multiplexing approach for MTCH(s) with inband per-packet control signaling. LTE MBMS may be implemented in terms of common subframe allocations and/MBMS or scheduling periods. Autonomously adjustable common TTI allocations for MBMS may deal with the presence of variable length flexible TTIs in the context of 5G NR.

A variety of protocol options may be implemented for different operational setups or use cases in 5G NR. Protocols may be self-contained. Protocols may be complementary considering practicalities of different 5G NR use cases.

5G NR DL and UL transmissions may be organized into radio (sub-)frames that may have variable duration and may be characterized by a number of fixed aspects such as location of DL control information and a number of varying aspects such as transmission timing or supported types of transmissions.

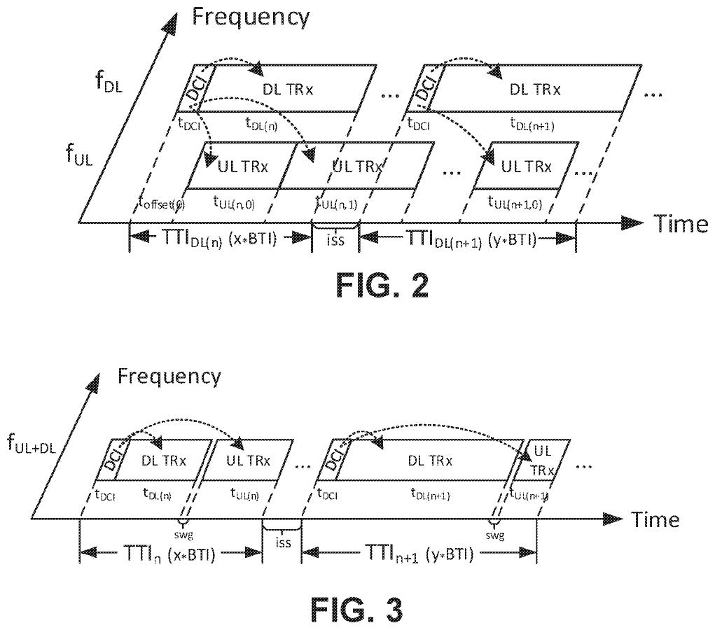

FIGS. 2 and 3 illustrate examples of framing and timing structures for 5G NR. FIG. 2 illustrates an example of framing and timing for 5G NR in FDD mode. FIG. 3 illustrates an example of framing and timing for 5G NR in TDD mode.

A basic time interval (BTI) may be expressed as a number of one or more OFDM symbol(s). Symbol duration may be a function of subcarrier spacing applicable to a time-frequency resource. Subcarrier spacing and/or OFDM channelization may (e.g., in 5G NR) differ for different channels multiplexed on a given carrier. Subcarrier spacing and/or OFDM channelization and parameterization may (e.g., for FDD) differ between the UL carrier frequency f_{UL} and the DL carrier frequency f_{DL}.

A transmission time interval (TTI) may be a minimum time supported by a system between consecutive transmissions that may (e.g., each) be associated with different transport blocks (TBs) for the DL (TTI_{DL}), for the UL (UL TRx). In an example, control information may be included, e.g., DCI for DL or UCI for UL. A TTI may be expressed as a number of one of more BTI(s) and/or as a function of OFDM channelization and parameterization.

A 5G NR (sub-)frame may contain downlink control information (DCI) of a certain time duration t_{dci}, and downlink data transmissions (DL TRx) on a concerned carrier frequency −f_{UL+DL} for TDD and f_{DL} for FDD. There may be multiple DCIs per transmission interval. The time-/frequency location of DCIs may occur before the data or DCI(s) may be multiplexed with data.

A frame may (e.g., for TDD duplexing) comprise a DL portion (e.g., DCI and DL TRx) and/or a UL portion (e.g., UL TRx). A switching gap (swg) may precede the UL portion of the frame, e.g., when present. A (sub-)frame may (e.g., for FDD duplexing) comprise a DL reference TTI and one or more TTI(s) for the UL. The start of a UL TTI may be derived, for example, using a timing offset (t_{offset}) applied from the start of a DL reference frame compared to the start of a UL (sub-)frame.

An asynchronous data transfer mode may be implemented by the WTRU and/or the TRP. The following examples may be described with respect to asynchronous data transfer in an MBMS context, but as noted above, the techniques and procedures described herein may be applicable to one or more other data transmission types. For example, MBMS may utilize asynchronous data transfer so that stream multiplexing may not rely on the existence of CSA and MSA. An asynchronous data transfer mode may overcome a disadvantage of semi-static TDM subframe patterns with associated large data payloads and limited support for high data rate MBMS (e.g., as may be used in LTE-based MBSFN mode). A stream-based approach may be implemented so that inband control packets carrying association tables with indices may announce MBMS service delivery and packet multiplexing. A WTRU may extract relevant MBMS content for one or more MBMS services of interest, for example, based on decoding using well-identified packet identifiers. A WTRU may learn which packet identifiers correspond to a service of interest and which ones may be scheduled for delivery, for example, by decoding association tables carried and transmitted on the MCH packet stream. In-band control signaling may carry sync packets serving a dual purpose of Rx in-sync/out-of-sync state maintenance and alignment of MTCH scheduling intervals.

MBMS data may be dynamically scheduled and transmitted from eNB to WTRU, for example, when unicast radio resources go unclaimed or become available (e.g., subject to reasonable WTRU DRX assumptions during MBMS reception). Different MTCHs carrying different MBMS services may be multiplexed dynamically, for example, on a per TTI or per-TB basis, e.g., without relying on a semi-static configuration such as MBMS fixed scheduling periods. This may (e.g., dramatically) decrease data delivery latency, which may be important for many MBMS scenarios such as MBMS when used as a V2X DL delivery mechanism. Small payloads with dynamic MCH resource allocation in time and frequency may be supported natively through asynchronous data transfer mode, which may be advantageous, for example, for MTC types of MBMS applications (e.g., firmware or software updates). A stream-based approach may operate in SC-PtM mode, e.g., similar to unicast PDSCH, and may operate in MBSFN mode. Additional transmitter timing coordination in the backhaul using a SYNC protocol or equivalent may (e.g., for MBSFN mode) be implemented, e.g., similar to LTE-based MBSFN mode. MBSFN mode vs. SC-PtM mode may be configured (e.g., at will and with much flexibility). For example, MBSFN mode and SC-PtM mode may be supported natively by the same packet data stream. The mode may be switched, e.g., dynamically.

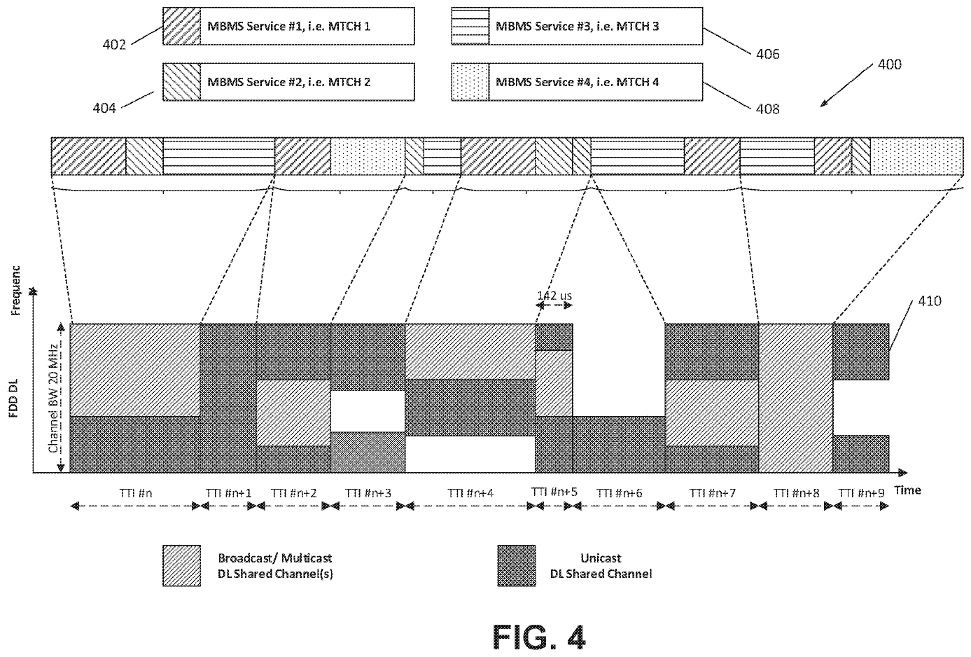

FIG. 4 illustrates an example of dynamic multiplexing of unicast and broadcast/multicast data using asynchronous multiplexing mode. FIG. 4 shows an example of an MBMS data packet stream 400 carrying multiple MBMS services 402, 404, 406, 408 when multiplexed with unicast data 410 in 5G NR. For simplicity, the case of an FDD DL carrier is shown.

Different MBMS services may be multiplexed into a DL broadcast/multicast (B/M) shared channel in a given subframe. A DL B/M shared channel may occupy all or partial bandwidth on an available DL FDD channel. Different subframes may have different time or TTI durations, for example, as suitably determined during DL scheduling. A DL B/M shared channel may or may not occupy the entire subframe length or TTI duration. For simplicity, FIG. 4 shows an example of contiguous bandwidth occupation and the use of entire duration for the variable length TTIs or subframes in transmissions. DL unicast shared channels may carry channels for one or multiple users. One or more DL B/M shared channels may be transmitted in a particular TTI or subframe, for example, in the lighter block regions in the example shown in FIG. 4. Multiple shared channels may correspond to different OFDM channelizations and parameterizations, for example, when multiple shared channels may be transmitted concurrently in the same subframe or TTI.

In an example with reference to FIG. 4, MBMS services or MTCHs 1-3 may be transmitted in TTI #n. Unicast data may be sent in TTI #n+1. In TTI #n+1, some bandwidth may be used for MBMS transmission carrying MBMS services corresponding to MTCH 1 and 4. TTI #n+2 may carry MTCH data from MBMS services #2 and #3. TTI #n+8 may carry broadcast/multicast data using full DL bandwidth.

An eNB may schedule DL unicast and/or DL B/M shared channel on a per-need basis. Incoming MBMS data packets corresponding to one or multiple MBMS services may be buffered in arbitrary order and may be temporarily queued for transmission, e.g., until DL radio resources become available in the eNB. MBMS transmission to WTRUs may be asynchronous and not time-aligned, e.g., not tied to a particular MBMS transmission schedule. A DL B/M shared channel may allow for reception by the WTRU of an (e.g., any) MBMS data packet that may belong to an MBMS service of interest upon decoding MBMS header and control information.

A WTRU may determine that one or more particular MBMS data packets multiplexed into the DL B/M shared channel may be of interest, e.g., based on decoding an MBMS identifier associated with a particular MBMS data packet. An MBMS identifier may be transmitted together with a MBMS data packet.

An MBMS service of interest may correspond to a MTCH. An MBMS identifier may correspond to a TMGI or MBMS session ID or flow identifier value derived based on one or more of these. An MBMS identifier may be carried as part of header or extended header information in an MBMS data packet.

An MBMS identifier may be conveyed and signaled implicitly, e.g., as part of an MBMS data packet. For example, an MBMS identifier may be conveyed to a WTRU encoded into a scrambling, masking or error check sequence.

An MBMS identifier may be carried and signaled through an L1 control signal associated with a transmission instance of a DL B/M shared channel. An L1 control channel may correspond to a scheduling message transmitted in a TTI or subframe. An L1 control channel may correspond to a DCI associated with a DL M/B shared channel.

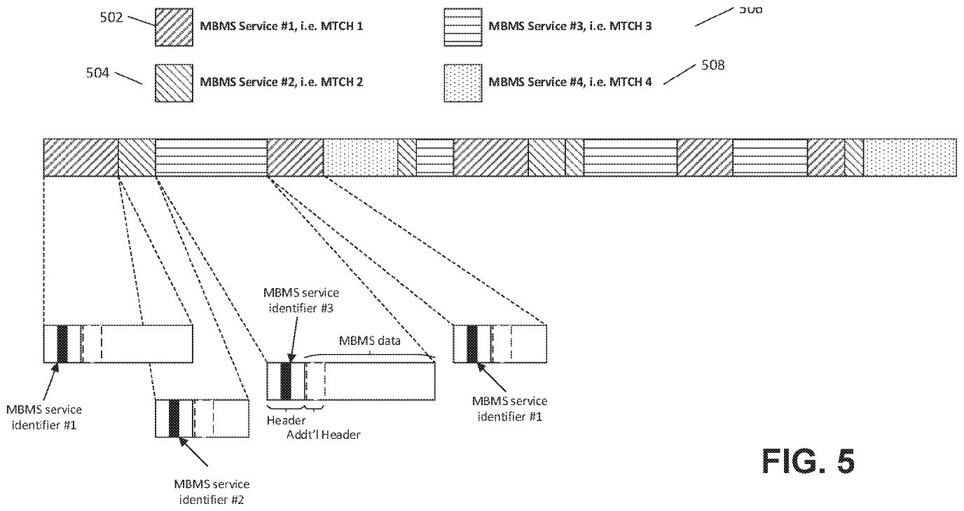

FIG. 5 illustrates an example of MBMS service identification with concurrently multiplexed MBMS services. FIG. 5 shows an example implementation of an MBMS packet identification mechanism. MBMS service 502 (e.g., MTCH 1) may use a first designated MBMS identifier. A second distinct MBMS identifier may be used for MBMS service 504 (e.g., MTCH 2). A WTRU may decode, store, and process incoming received MBMS data packets identified for MBMS service 502, for example, using a first designated MBMS identifier corresponding to an MBMS service of interest. A WTRU interested in reception of MBMS service 502 (e.g., MTCH 1) may discard decoded data for MTCH 2, for example, upon determination of the presence of the second MBMS identifier.

Information included in an MBMS data packet may correspond, for example, to bit flags, information elements, configuration index representing a priority, sequence numbering, start or end of segment, presence or absence of additional headers, field length, error check sequences or error indicators, transport format, and/or encoding format.

A WTRU may determine which MBMS service may be associated with a particular MBMS identifier upon reception and processing of MBMS control packets multiplexed in an MBMS packet data stream.

MBMS control packets may contain an MBMS identifier occurrence associated with the reception of a particular MBMS service of interest. A WTRU may determine an MBMS identifier that may be used for filtering an MBMS packet data stream, e.g., to identify corresponding data packets from the MBMS association table or index carried in an MBMS control packet.

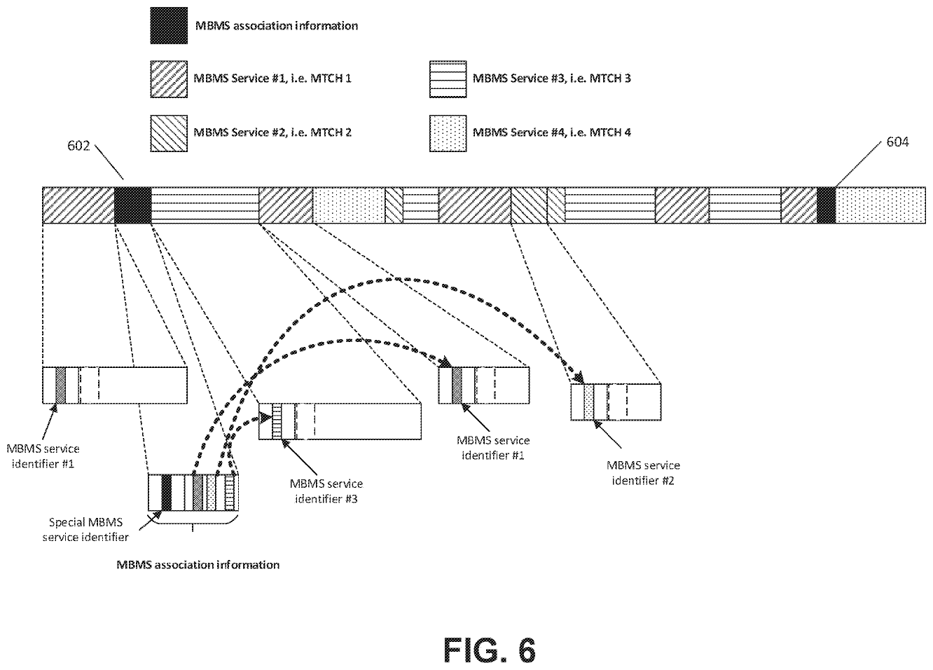

FIG. 6 illustrates an example of MBMS association information with concurrently multiplexed MBMS services. FIG. 6 shows an example implementation of signaling for MBMS association information 602, 604. An MBMS control packet may be transmitted one or more times multiplexed into the MBMS packet data stream. An MBMS control packet may correspond to an MCCH and/or MSI. An MBMS control packet may contain information about MBMS services available in the area, their associated transmission and/or reception parameters, scheduling, and configuration information.

Additional information included in an MBMS control packet may include some or all description for MBMS data packets. Additional information may include, for example, bit flags, information elements, configuration index representing an active period, presence, number, ordering, expected duration of transmission for MBMS data packets, transmit schedule, or their transport and/or encoding format.

An MBMS control packet may or may not be sent at regularly occurring time intervals. A WTRU may determine presence of MBMS association information, e.g., an MBMS control packet based on a special MBMS identifier. A special MBMS service identifier may be designated, e.g., fixed, or it may be configurable. A configurable service identifier may, for example, be determined by the WTRU as part of MBMS system acquisition.

A WTRU may (e.g., upon reception of an MBMS packet data stream carrying multiplexed MBMS services) attempt to find and decode MBMS control packets, e.g., MBMS association information by searching for packets carrying a special MBMS identifier. A WTRU may (e.g., once MBMS association information may be identified by a WTRU) process MBMS transmission and/or reception parameters for advertised MBMS services and any associated identifiers. A WTRU may use the determined MBMS identifier and corresponding MBMS configuration, which may include scheduling information for a service of interest, to start decoding incoming MBMS data packets in the multiplexed shared MBMS packet data stream.

MBMS association information may be present, for example, in the form of multiple dependent MBMS control packets, which may be hierarchical or sequential. For example, a first MBMS control packet using reserved MBMS identifiers may contain (e.g., only) active MBMS service information. A second MBMS control packet, which may be decodable based on information obtained by processing the first MBMS control packet, may contain actual identifiers and/or transmission configuration for MBMS data streams corresponding to a particular MBMS service of interest.

A first MBMS control packet may be used to advertise active and/or offered MBMS services in an area including MBMS identifiers that may be needed to identify a second MBMS control packet advertising MBMS identifiers for MBMS services of interest.

MBMS association information that may be used to decode MBMS services of interest in part of a MBMS data packet stream may be obtained by a WTRU through configuration signaling on a separate signaling channel.

For example, MBMS identifiers and/or associated transmission parameters may be obtained by a WTRU, for example, upon connecting to a serving cell. A WTRU may use an RRC signaling message. A WTRU may (e.g., upon reception of a configuration message from the network) determine appropriate MBMS identifiers. A WTRU may decode MBMS data stream packets for an MBMS service of interest using a determined MBMS identifier. MBMS related information including MBMS identifiers may (e.g., alternatively or in conjunction) be obtained by the WTRU through an MBMS service announcement or service activation signaling mechanism.

A WTRU may determine timing information from packets multiplexed in an MBMS packet data stream.

Timing-related information included in an MBMS data or control packet may correspond to, for example, bit flags, information elements, configuration index representing a time stamp, counter, hop numbering or count, sync priority, time offset, and/or uncertainty value. Timing-related information may include synchronization sequences.

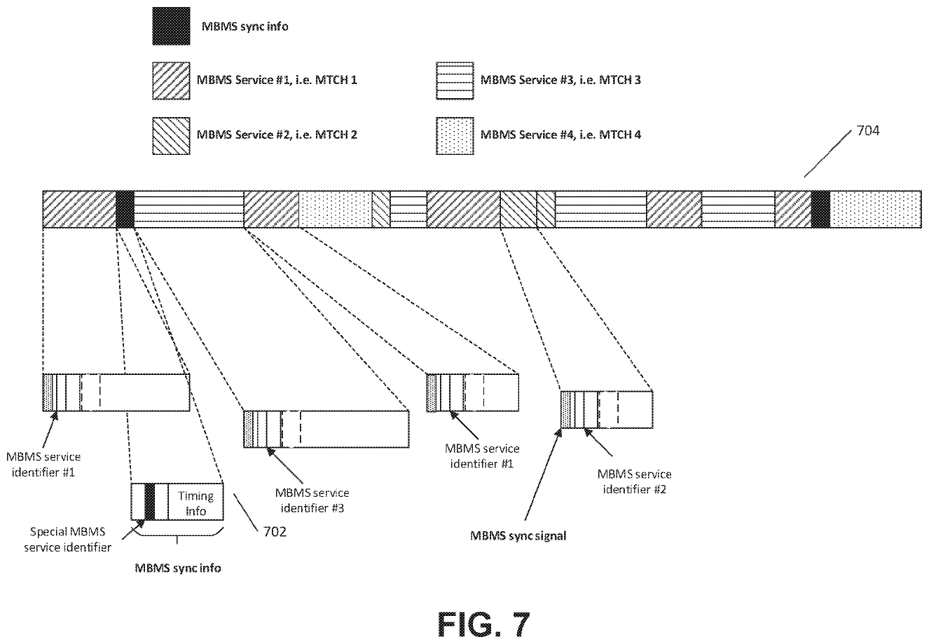

FIG. 7 illustrates an example of MBMS content delivery and/or timing synchronization between an eNB and WTRU. FIG. 7 shows a first example implementation of a timing determination by a WTRU. An MBMS timing control packet 702 may be transmitted one or more times, e.g., multiplexed into an MBMS packet data stream 704. An MBMS timing control packet may or may not be sent at regularly occurring time intervals. A WTRU may determine the presence of MBMS timing information, e.g., an MBMS control packet, for example, based on designated or configurable identifiers. A WTRU may (e.g., upon reception of a timing control packet) adjust its receiver timing or may determine a subsequent reception or scheduling period. A WTRU may process following MBMS data packets according to determined transmission parameters.

FIG. 7 shows a second example implementation of a timing determination by a WTRU. Some or all designated MBMS data packets may carry a timing information or sync header or preamble, e.g., in support of WTRU timing synchronization. A WTRU may (e.g., upon reception of an MBMS data packet carrying a timing or sync information field or header) adjust its receiver timing, e.g., for a portion or all of an MBMS data packet stream.

Multiplexing timing information into an MBMS data packet stream may support initializing, setting, and controlling synchronized reception of MBMS transmission or scheduling intervals. For example, timing control may be transmitted by an eNB and may be used by a WTRU upon reception to configure the start, end, or duration of an MBMS service, scheduling, or DRX period. Timing information inserted by a transmitter or transmitters into an asynchronous MBMS data packet stream may be used by a WTRU to align, set, adjust, or configure reception timing for MBMS transmission periods in MBSFN mode. Timing information may be used by a WTRU, for example, as criteria for in-sync/out-of-sync reception of an MBMS data stream. A WTRU may be in valid reception conditions (e.g., in-sync and may continue reception), for example, when N1 packets carrying timing information are successfully received (e.g., in sequence or during an observation interval). A WTRU may be out-of-sync and may terminate reception, for example, when N2 packets carrying timing information are not received.

A timing-based data transfer mode may be implemented. Timing-based data transfer may be based on common MBMS subframe allocations and/or MBMS scheduling periods configured for WTRUs. MCCH and MSI may be transmitted (e.g., in some designated MBMS carrying subframes) to determine further processing by a WTRU of any received MTCH(s). A radio resource allocation procedure may (e.g., to cope with dynamically adjusted variable length shared (sub-)frames in NR MBMS) use autonomously adjustable common (AAC) TTI allocations, patterns, and scheduling periods for MBMS. A transmission opportunity may be based on one or more (e.g., implicit) rules that may relate to a previous transmission. Allowed start timing for possible MBMS transmissions may be compared with the start of dynamic variable-length DL subframes (or TTIs). MBMS start timing may be adjusted accordingly. Timing rules may be determined or received, for example, as part of an AAC configuration. A WTRU may perform an earlier/later determination for a (e.g., every) CSA. A procedure may be used to coordinate MBMS transmission and reception timing between eNB and WTRU. A procedure may be GPS based, e.g., using universal timing. A procedure may be SFN-based, e.g., relative timing may be determined by a reference cell.

Examples of the timing rules for determining which subset of symbols in a AAC allocation may be used for transmission may include timers related to reference signals or observed events. For example, a first rule may define that a first opportunity may occur a first time length after the start of an allocation period. A second rule may indicate that the second opportunity may occur a second time period after the first opportunity if a transmission did occur during the first opportunity. A third rule may indicate that the second opportunity may occur a third time period after the first opportunity if a transmission did not occur during the first opportunity. Thus, the timing of subsequent transmissions opportunities within an allocation period may depend on whether transmission did or did not occur within a previous transmission opportunity. The rules may be signaled in the configuration using timers.

In an example, the rules may be decoupled from TTI or subframe numbers, for example since TTIs/subframes may be of various lengths. The rules may be implemented using absolute time, OFDM symbol counts, BTI counts, and/or based on other timing references (e.g., GPS, system frame number (SFN), downlink reference signal transmission, downlink synchronization signal transmission, etc.).

LTE-based eMBMS specifications and implementations may be applied in the presence of (e.g., essential) changes to the context of 5G New Radio (NR). MBSFN mode may be (e.g., more easily) employed for MBMS data delivery, for example, due to coordinated TTI allocation patterns and scheduling periods. A timing-based approach may be useful in urban micro or macro cells, for example, where high MBMS data rates at cell edge may utilize SFN.

Autonomously adjustable common TTI allocations for MBMS may be provided.

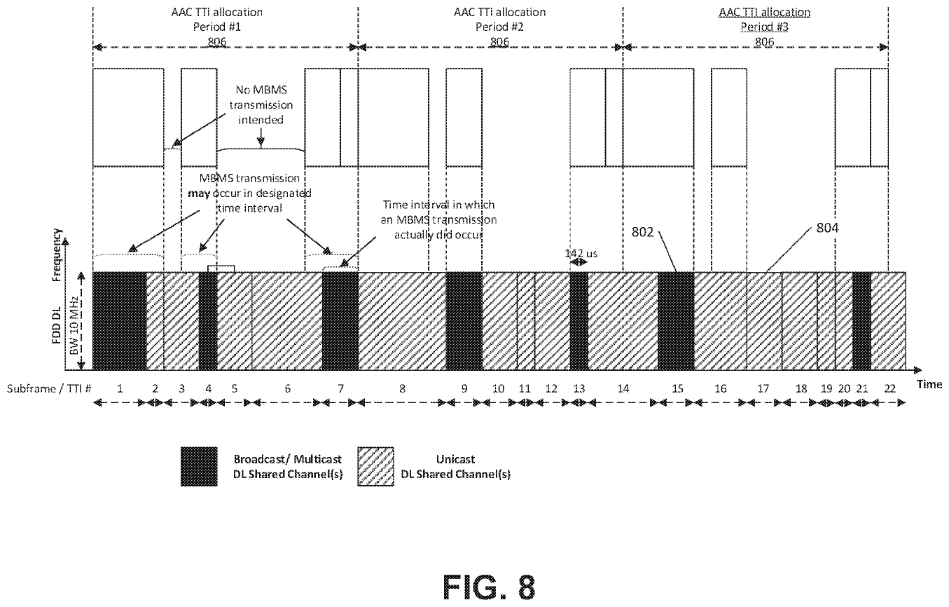

FIG. 8 illustrates an example of autonomously adjustable common TTI allocations for MBMS transmission and reception. FIG. 8 shows an example transmission sequence where MBMS data 802 may be multiplexed with unicast data 804 in 5G NR. For simplicity, the example shows an FDD DL carrier.

Different MBMS services may be multiplexed into a DL broadcast/multicast (B/M) shared channel in a given subframe. A DL B/M shared channel may occupy all or partial bandwidth on an available DL FDD channel. Different subframes may have different time or TTI durations, which may be determined during DL scheduling. A DL B/M shared channel may or may not occupy the entire subframe length or TTI duration. FIG. 8 shows an example of contiguous bandwidth occupation and use of an entire duration for the variable length subframes in the transmissions. DL unicast shared channels may carry channels for one or multiple users. One or more DL B/M shared channels may be transmitted in a particular TTI or subframe in one or more lighter-colored block regions in FIG. 8. These may correspond to different OFDM channelizations and parameterizations, for example, when multiple shared channels are transmitted concurrently in the same subframe or TTI.

FIG. 8 shows an example of variable TTIs and subframe durations during DL scheduling, which, for example, may be integer multiples of 2 LTE nCP OFDM symbol intervals, a basic TTI, or time unit (e.g., approximately 142 us). A TTI or time unit (TU) may be adapted to different values of reference time instants or intervals.

An eNB may configure (e.g., well-defined) time intervals, which may be referred to as Autonomously Adjustable Common (AAC) TTI allocation, during which an eNB may transmit MBMS data and control channels to WTRUs desiring to receive MBMS content. The AAC TTI allocation may be an example of a configuration that indicates to the WTRU possible transmission opportunities for MBMS data. The AAC TTI allocation may indicate possible transmission opportunities for other types of data in addition to or alternatively to MBMS data. Additional discussion and examples are provided for a time interval and well-defined timing (e.g., to establish a common time reference for eNBs and WTRUs during which MBMS transmission may occur).

An AAC TTI allocation period for potential MBMS (and/or other) transmissions may have a duration. For example, the AAC TTI allocation pattern period 806 in FIG. 8 may have duration of 15*142 us (e.g., approximately 2.13 ms). The AAC TTI allocation periods may repeat over time. The configuration may be used to derive a subset of times during an AAC TTI allocation period that may be used for potential MBMS (and/or other) transmission. For example, the configuration may indicate that for AAC TTI allocation pattern period 806, 9 of the 15 BTIs may be available for MBMS (and/or other) transmissions. The configuration may define one or more rules used to define which of the 9 BTIs correspond to the BTIs when a transmission can occur. For example, the rules may be the same from allocation period to allocation period or may change from one allocation period to the next. As shown in example AAC TTI allocation pattern period 806, 9 (e.g., 9*142 us e.g. or approximately 1.28 ms) of the 15 BTIs may be possible candidate transmission and reception time intervals where an eNB may choose to transmit MBMS data or control. A WTRU may not be expected to decode for presence of MBMS data and control in remaining (e.g., 6) time intervals not designated for MBMS during AAC TTI allocation.

A WTRU may maintain a first timing reference with respect to a configured AAC TTI allocation for MBMS transmission and a second timing reference with respect to scheduled DL TTIs or subframes. A WTRU may compare first and the second timing reference, e.g., to determine whether a particular transmission instant is an allowed transmission interval according to a configured AAC TTI allocation. The comparison of the two timing references may be an example of a rule defined in the configuration for the allocation period.

TTI #1 may have a length of three time units (TUs) (e.g., BTIs). MBMS data and/or control channels may be scheduled by the eNB and transmitted. The first four TUs may be a valid part of the MBMS on-duration for the configured AAC TTI allocation pattern. In TTI #2 or length # TU, unicast data may be transmitted to one or multiple WTRUs. TTI #2 may be part of a valid MBMS transmission on-duration. An eNB may or may not transmit MBMS data or control. A WTRU receiving an MBMS service of interest may determine (e.g., in a given TTI or subframe that may be part of a valid MBMS on-duration in a configured AAC TTI allocation) whether MBMS data or control is being transmitted by an eNB. A WTRU may implement one or more (e.g., a combination) of procedures to determine presence or absence of an MBMS data or control transmission, e.g., as described herein.

TTI #5 and TTI #6 may not be a valid time interval for transmission and/or reception of MBMS data or control according to an example configured AAC TTI allocation pattern in FIG. 8. A WTRU may determine that the beginning and entire duration of TTI #5 may not be part of a valid MBMS on-duration. A WTRU (e.g., consequently) may not attempt to decode for presence of MBMS data or control during TTI #5. A WTRU may determine that the beginning of TTI #6 does not fall in a valid MBMS on-duration, although a second portion of TTI #6 may be part of the next upcoming MBMS on-duration part of the configured AAC TTI allocation pattern. A variety of examples of WTRU procedures are described herein, for example, to allow for determination of valid start of potential MBMS data or control transmission periods.

TTI #7 may (e.g., again) be part of a valid MBMS on-duration, which may comprise separate portions of the configured AAC TTI allocation pattern. A WTRU receiving MBMS may determine presence of MBMS data and control. The eNB may transmit MBMS data or control in TTI #7.

A WTRU may be configured with an autonomously adjustable common TTI allocation that may be defined using a reference time duration and reference timing, e.g., for MBMS or other data reception and/or transmission. Timing rules may be determined or received as part of the AAC configuration. An AAC TTI allocation may differentiate between a first set of time intervals in which an MBMS transmission by an eNB may occur and a second set of time intervals in which MBMS transmission from the eNB may not be expected.

The start, end, and/or duration of an AAC TTI allocation may configured with respect to a reference time instant. Thus, a received configuration may indicate start, end, and/or duration of an AAC TTI allocation. An AAC TTI allocation may repeat as a pattern, e.g., with different possible reference time instants or timing offset values. Multiple AAC TTI allocations may be configured for a WTRU receiving MBMS and/or other services of interest. These may correspond to different MBMS services or MBMS data or control channels. Different AAC TTI allocations (e.g., including their parameterization with respect to reference time duration or reference timing) may be configured for different MBMS WTRUs or for MBM reception or may be assigned for Idle or Connected Mode operation or on different channels. Different AAC TTI allocations may be concurrent or may overlap. AAC TTI allocations may be signaled to WTRUs or may be obtained by a WTRU from stored or pre-configured information.

MBMS on- and off-durations or time intervals during which MBMS transmission from the eNB may or may not be expected may be configured, for example, as a bitmap or bit string. A repetition period and reference timing may be configured for AAC TTI allocation pattern lengths. An AAC TTI allocation period may be referred to as a Common Subframe Allocation. A number of repeated AAC TTI allocations may correspond to an MBMS scheduling period.

A WTRU configured with autonomously adjustable common TTI allocation may maintain a first timing reference with respect to a configured AAC TTI allocation for MBMS transmission and a second timing reference with respect to timing of received DL TTIs or subframes. A WTRU may compare the first and second timing references, for example, to determine whether a particular transmission instant is an allowed transmission interval according to a configured AAC TTI allocation. The comparison of the timing references may be an example of a rule defined in the configuration.

A first timing reference may count time intervals in absolute units of time or a number of OFDM, channel symbols or TTIs. A first timing reference may be adjusted to skip counting designated time intervals, for example, when certain types of transmission activity may be (e.g., are) determined present or absent. A second timing reference may correspond to an SFN, a TTI, subframe or frame counter. A second timing reference may include transmission activity, for example, in terms of counting or not counting when in presence or absence of designated channels or signals. For example, the second timing reference may correspond to the reception of an MBMS or other transmission (e.g., during one of the BTIs determined as being allowed for transmission based on the AAC configuration).

A WTRU configured with an AAC TTI allocation may monitor DL channels or signals for eNB transmissions. A WTRU may attempt to receive and decode DL channels or signals continuously (e.g., in every TTI) or for some determined reception time periods, for example, when subject to DRX rules. A WTRU may determine the start of a scheduled DL subframe or TTI and/or may determine length or duration for a particular transmission instance of the TTI or subframe. A WTRU may determine (e.g., based on a first timing reference for a configured AAC TTI allocation and a second timing reference of the DL subframes or TTIs) whether a DL subframe or TTI is allowed for MBMS transmissions. If so, a WTRU may (e.g., when a DL subframe or TTI is allowed) attempt to receive and decode MBMS data or control or a signal channel associated with transmission thereof. A WTRU may implement portions of a procedure in parallel and/or serially, e.g., in conjunction with other portions.

A validity determination for MBMS reception of a particular TTI or subframe according to a configured AAC TTI allocation may be performed in a variety of individually implemented or combined procedures.

A WTRU may consider a DL subframe or TTI valid for MBMS reception, for example, when it is determined that a starting TTI or subframe boundary timing may occur later than the time of an MBMS on-period according to a configured AAC TTI allocation. A WTRU may (e.g., alternatively) consider a valid DL subframe or TTI, for example, when an MBMS on-duration fits (e.g., entirely) in a duration of a TTI or subframe, e.g., as determined by the WTRU. A WTRU may (e.g., alternatively) consider valid for MBMS reception a DL subframe or TTI that may start prior to the end of a current MBMS on-duration, e.g., as determined by a first timing reference maintained by the WTRU with respect to the AAC TTI duration. A WTRU may (e.g., alternatively) consider valid for MBMS reception an N DL subframe or TTI following an eMBMS transmission by the eNB in an MBMS on-period. A WTRU may (e.g., alternatively) consider valid for MBMS reception a TTI or subframe in which an MBMS control channel or signal may be received during the AAC TTI allocation (e.g., for a pre-determined duration or timing or counter value).

A timing reference may be determined. An MBMS WTRU may use one or more (e.g., a combination) of procedures to maintain a well-defined timing reference with respect to its configured AAC TTIs allocations, for example, to determine whether MBMS transmission is possible during an MBMS on-duration or whether MBMS transmission is not expected during an MBMS off-duration.

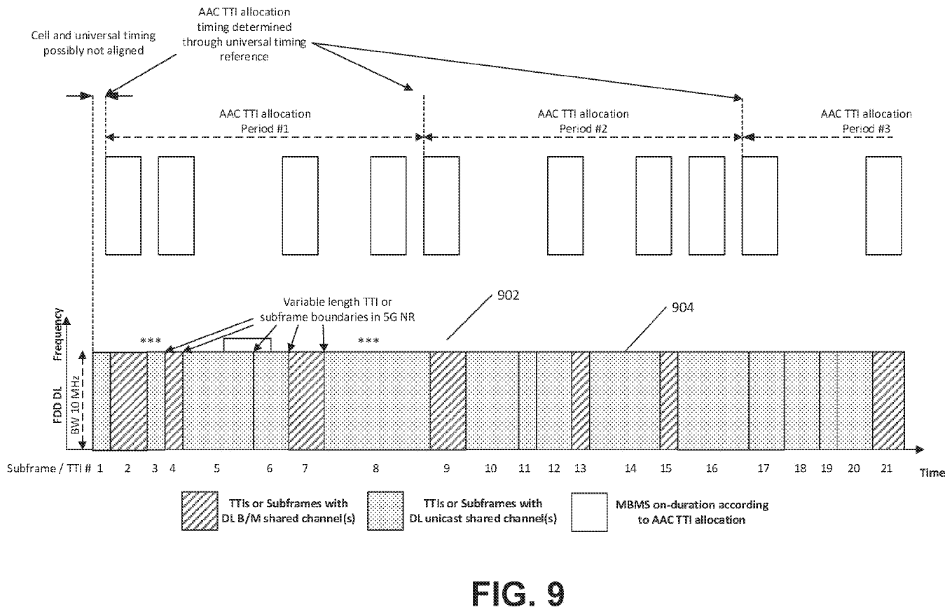

FIG. 9 illustrates an example of an MBMS reference timing determination using a universal timing source. FIG. 9 shows an example transmission sequence where MBMS data 902 may be multiplexed with unicast data 904 in 5G NR. For simplicity, an example of an FDD DL carrier is shown.

Variable TTIs and subframe durations during DL scheduling may be integer multiples of 2 LTE nCP OFDM symbol intervals, a basic TTI or time unit (e.g., approximately 142 us). A TTI or time unit (TU) may be adapted to different values or reference intervals.

An eNB configured for transmission of MBMS and a WTRU intending to receive MBMS may determine and may maintain MBMS reference timing for AAC TTI allocations, e.g., TTIs or subframes in which MBMS transmission may occur or in which they may not be expected using a timing source based on GPS universal timing. Thus, one or more rules defined in the configuration for indicating a potential transmission opportunity may be based on GPS timing.

A starting time for an example AAC TTI allocation pattern may be determined from a time instant defined or derived using GPS universal timing. An AAC TTI allocation may start at integer increments (e.g., of 100 us time units). For example, MBMS data or control may be present in MBMS on-durations, which may be defined to start at X1 hours X2 min X3 sec X4 ms and 100, 200, 300, . . . 900, 1000 us. A TTI on- or off-duration may correspond to integer multiples of a (e.g., basic) GPS timing derived time unit, e.g., multiples of 100 us.

MBMS data or control transmission may be scheduled by the eNB (e.g., in subframe or TTIs #2, 4, 7 etc.), for example, because both universal timing sources in eNB and MBMS WTRUs may determine that the corresponding transmission intervals belong to a valid MBMS on-duration. MBMS transmission may not take place (e.g., in subframe or TTIs #10 or 11), for example, when TTIs belong to an MBMS transmit off-duration according to the common timing reference maintained by eNB and MBMS WTRUs.

Starting instants for MBMS on-durations (e.g., based on universal timing) and beginning of DL TTIs or subframes (e.g., as determined by ENB scheduling) may not align. A WTRU may determine (e.g., for misalignment) whether a particular TTI or DL subframe may be a valid MBMS data or control transmission interval (e.g., according to rules).

A WTRU may determine MBMS transmission timing, for example, using an available universal timing source such as GPS. Other (e.g., alternative or supplemental) universal timing sources, satellite based, or terrestrial timing beacons may be used to determine timing.

MBMS transmission timing may refer to one or more (e.g., a combination) of an MBMS transmission starting time instant, an MBMS transmission duration or interval, an MBMS on-duration or transmit off-duration, and/or an MBMS transmission allocation (e.g., AAC TTI allocation).

A GPS universal timing based reference may include signaled or configured offset values or timing reference adjustment parameters.

A WTRU may maintain a first timing reference (e.g., based on GPS) that may be adjusted by a given timing reference adjustment configuration, for example, when an MBMS timing reference using a universal timing reference such as GPS is signaled or configured. A WTRU may determine updated timing values based on the universal timing reference and the timing adjustment parameters, for example, when signaled or configured timing adjustment parameters are to be accounted for in the determination of MBMS transmissions. A WTRU may compare a universal timing derived timing reference to received DL TTIs or subframes, for example, to determine whether an MBMS data or control transmission may or may not occur according to the AAC TTI allocation.

MBMS transmission or scheduling periods using a universal timing source, reference configurations or index representations may be used, for example, to reduce signaling and memory overhead, e.g., when configuring AAC TTI allocations. AAC TTI allocation patterns (e.g., where a possible starting time instant is incremented in integer multiples of 100 us with respect to universal reference timing) may use a first index value while starting time instants of integer multiples of 200 us may use a second index value. A third index value may represent possible starting times for the MBMS allocation in integer units of 200 us combined with possible MBMS transmit on-durations of integer multiple of 1 ms, etc. Combinations of index values and reference configurations may be derived based on universal timing reference. Indices and compact representations may be signaled from eNB to WTRU, e.g., in lieu of explicit GPS universal timing formats that may require a larger payload.

A WTRU may determine available or valid MBMS radio resource allocations in a given area, such as AAC TTI allocation as a function of its GPS determined location.

Availability of an absolute timing (and location) reference (e.g., GPS for MBMS resource allocation), which may include possible adjustment parameters, may be used for MBMS resource allocation (e.g., to achieve spatial reuse for MBMS data delivery), for example, in an area where MBMS services are provided.

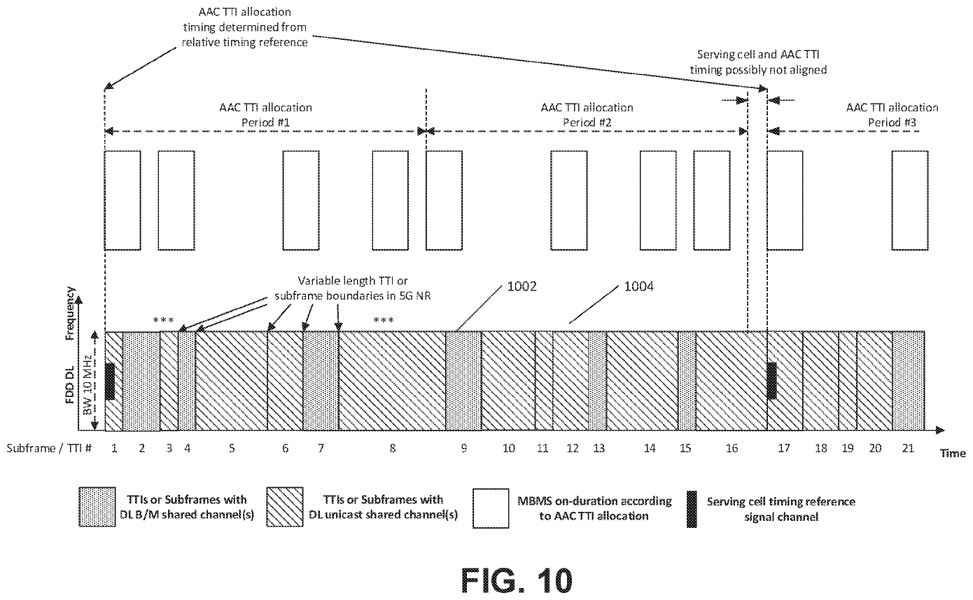

FIG. 10 illustrates an example of MBMS reference timing determination using a relative timing source. FIG. 10 shows an example transmission sequence where MBMS data 1002 may be multiplexed with unicast data 1004 in 5G NR. For simplicity, the example shows an FDD DL carrier.

5G NR serving cell timing may be determined by a WTRU intending to receive an MBMS service of interest. Serving cell timing may be represented, for example, by a system frame number (SFN) or another counter employed in cellular communications.

Serving cell timing may be determined, for example, using the occurrence of a well-defined DL common control channel or signal depicted in TTIs #1 and 17. A reference DL channel or signal may itself carry a system frame counter or may carry parts of the bit representation of such a counter. A system frame counting value may be (e.g., only) partially carried or encoded and may be fully derived by a WTRU (e.g., by complementary means such as WTRU determination of a signaling encoding sequence). A reference DL channel or signal may (e.g., alternatively) be used to indicate, for example, when the system frame counter starts at 0, re-initializes to a certain well-determined value X, or equivalent, without carrying an actual system frame number value.

Two consecutive AAC TTI allocations may be shorter than the period between the two instances of a serving cell timing reference signal channel. There may be a gap where no MBMS transmission may occur due to an adjustment of the MBMS transmission schedule by eNB and/or WTRU. The next valid AAC TTI allocation pattern may start with the beginning of TTI #17.

A WTRU may determine MBMS transmission timing, for example, using a reference timing source derived on a serving cell. A WTRU may adjust MBMS transmission timing, which may be provided by a configured AAC TTI allocation pattern, repetitions, or MBMS scheduling periods that may be determined based on these as a function of the reception timing instant for the serving cell timing reference signal. For example, as shown in TTI #17, the WTRU may re-align the start of allocation period #3 with a serving cell timing reference channel after detecting the reference channel. In this manner, the WTRU can ensure that it periodically re-synchronizes the allocation periods the allocation periods determined at the base station.

As shown in FIG. 10, the available transmission opportunities in a first allocation period may be different from the transmission opportunities within the next (or subsequent) allocation period. For example, the opportunities may be based on observed transmission occurrences within the allocation period and thus may be different in different allocation periods.

MBMS transmission timing may refer, for example, to one or more (e.g., a combination) of the following: an MBMS transmission starting time instant, an MBMS transmission duration or interval, an MBMS on-duration or transmit off-duration, and/or an MBMS radio resource allocation (e.g., AAC TTI allocation). The rules indicated in the configuration may define which events (and/or the timing with respect to such events) should be used for deriving the transmission opportunities within the allocation period.

An MBMS WTRU may determine the value of a system frame counter for a serving cell, for example, when use of an MBMS timing reference based on a relative timing reference such as SFN is signaled or configured. An MBMS WTRU may determine a start instant, duration, and/or number of repetitions of an AAC TTI allocation with respect to the determined system frame counter. Configured or signaled offset or adjustment parameters may be accounted for by the WTRU, for example, when determining candidate MBMS transmission intervals with respect to serving cell timing. An MBMS WTRU may adjust possible MBMS on- or off-duration time intervals, for example, to adjust for irregular or aperiodically occurring serving cell timing reference signal channels or in cases where AAC TTI patterns do not fit as multiple integer time intervals. A WTRU may advance or defer MBMS reception as a function of the determined MBMS timing adjustment.

Systems, methods, and instrumentalities have been disclosed for 5G NR broadcast multicast data transmission. Example procedures or protocols are provided for downlink (DL) control and data transmission, DL Scheduling and L2/3 user plane. Asynchronous data delivery may be provided for MBMS. Stream-based multiplexing may be provided with association tables/indices. DL L2/3 Uu design may support scheduling in MBSFN and SC-PtM modes. Timing-based data delivery may be provided for MBMS. Coordinated TTI allocations may be autonomously adjustable. Absolute or relative reference timing may be provided for MBMS data. MBMS data delivery may be scheduled and acquired by WTRUs in the presence of variable TTIs and flexible timing relationships between control and data signaling. Radio resource allocation may be flexible in time and frequency domains considering MBMS and unicast data delivery to terminals. Seamless transition and inter-operability may be provided between unicast-based, SC-PtM-based and MBSFN-based MBMS data delivery modes. MBMS may be operated using multiple concurrently configured MBMS channelization and transmission configurations. MBMS reception may be enabled without relying on always-on DL control and system information signaling.

The processes and instrumentalities described herein may apply in any combination, may apply to other wireless technologies, and for other services.

A WTRU may refer to an identity of the physical device, or to the user's identity such as subscription related identities, e.g., MSISDN, SIP URI, etc. WTRU may refer to application-based identities, e.g., user names that may be used per application.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as CD-ROM disks, and/or digital versatile disks (DVDs). A processor in association with software may be used to implement a radio frequency transceiver for use in a WTRU, terminal, base station, RNC, and/or any host computer.

1. A method implemented by a wireless transmit/receive unit (WTRU) for providing asynchronous data delivery, the method comprising:
receiving a configuration indicating a plurality of rules for determining transmission opportunities for downlink transmissions;
identifying a downlink timing reference;
determining a first transmission opportunity in which the downlink transmission can occur based on the downlink timing reference and a first rule of the plurality of rules; and
determining a second transmission opportunity in which the downlink transmission can occur based on whether data was transmitted in the first transmission opportunity and a second rule associated to the plurality of rules.

2. The method of claim 1, wherein the second rule is based at least in part on a duration of a downlink transmission received before the second transmission opportunity.

3. The method of claim 1, wherein the first rule is based on a first timer that is started based on the downlink timing reference.

4. The method of claim 3, wherein the second rule is based on the first timer and on a second timer related to the first transmission opportunity.

5. The method of claim 1, wherein the second rule is based on a duration of a downlink transmission received during the first transmission opportunity.

6. The method of claim 1, wherein the configuration comprises an indication of a first time interval during which the WTRU is able to receive the downlink transmission and an indication of a second time interval during which the WTRU is not expected to receive the downlink transmission.

7. The method of claim 1, wherein the downlink timing reference comprises a universal timing reference.

8. The method of claim 1, wherein the downlink timing reference comprises a relative timing reference.

9. The method of claim 1, wherein the first transmission opportunity comprises a transmission opportunity for reception of a multimedia broadcast multicast service (MBMS) transmission.

10. The method of claim 1, further comprising adjusting the WTRU to receive the downlink transmission based on the second transmission opportunity.

11. A wireless transmit/receive unit (WTRU) comprising:
a memory;
a receiver configured to receive a configuration indicating a plurality of rules for determining transmission opportunities for downlink transmissions; and
a processor configured to:
identify a downlink timing reference;
determine a first transmission opportunity in which the downlink transmission can occur based on the downlink timing reference and a first rule of the plurality of rules; and
determine a second transmission opportunity in which the downlink transmission can occur based on whether data was transmitted in the first transmission opportunity and a second rule of the plurality of rules.

12. The WTRU of claim 11, wherein the second rule is based at least in part on a duration of a downlink transmission received before the second transmission opportunity.

13. The WTRU of claim 11, wherein the first rule is based on a first timer that is started based on the downlink timing reference.

14. The WTRU of claim 13, wherein the second rule is based on the first timer and on a second timer related to the first transmission opportunity.

15. The WTRU of claim 11, wherein the second rule is based on a duration of a downlink transmission received during the first transmission opportunity.

16. The WTRU of claim 11, wherein the configuration comprises an indication of a first time interval during which the WTRU is able to receive the downlink transmission and an indication of a second time interval during which the WTRU is not expected to receive the downlink transmission.

17. The WTRU of claim 11, wherein the downlink timing reference comprises a universal timing reference.

18. The WTRU of claim 11, wherein the downlink timing reference comprises a relative timing reference.

19. The WTRU of claim 11, wherein the first transmission opportunity comprises a transmission opportunity for reception of a multimedia broadcast multicast service (MBMS) transmission.

20. The WTRU of claim 11, wherein the processor is configured to adjust the receiver to receive the downlink transmission based on the second transmission opportunity.
